(19) United States
(12) Patent Application Publication
(10) Pub. No.: US 2016/0177897 A1
(43) Pub. Date: Jun. 23, 2016

(54) SUPERCHARGER FOR ENGINE

(71) Applicant: KAWASAKI JUKOGYO KABUSHIKI KAISHA, Kobe-shi (JP)

(72) Inventors: Shohei Naruoka, Kakogawa-shi (JP); Koyo Fujiwara, Akashi-shi (JP)

(21) Appl. No.: 14/953,904

(22) Filed: Nov. 30, 2015

(30) Foreign Application Priority Data
Dec. 18, 2014 (JP) 2014-256276

(51) Int. Cl. F02M 35/10; F04D 29/28; F02B 61/02; F04D 29/42; F02B 33/40; F04D 17/10; F04D 29/44

(52) U.S. Cl. CPC F02M 35/10157; F04D 17/10; F04D 29/284; F04D 29/441; F04D 29/4206; F02B 33/40; F02B 61/02

(57) ABSTRACT

A supercharger pressurizes intake air for an engine. The supercharger includes a centrifugal impeller and an impeller housing covering the impeller. The impeller housing has a spiral chamber which forms a discharge passage for air compressed by the impeller; and a diffuser chamber defined downstream of the spiral chamber. A portion of an inner surface of the diffuser chamber is ground such that a ground region has a surface roughness less than that of a non-ground region.

### CROSS REFERENCE TO THE RELATED APPLICATION

This application is based on and claims Convention priority to Japanese patent application No. 2014-256276, filed Dec. 18, 2014, the entire disclosure of which is herein incorporated by reference as a part of this application.

### BACKGROUND OF THE INVENTION

1. Field of the Invention

The present invention relates to a supercharger including a centrifugal type impeller which pressurizes intake air for an engine.

2. Description of Related Art

An engine has been known in which a supercharger is provided to pressurize intake air, in order to improve an output of the engine (e.g., JP Laid-open Patent Publication No. H05-256146). In the engine in JP Laid-open

Patent Publication No. H05-256146, a mechanical supercharger including a centrifugal type impeller is used.

In an engine equipped with a centrifugal type supercharger, since intake air is pressurized, the intake air temperature is rendered to be high. When the intake air temperature becomes high, charging efficiency to a cylinder decreases, whereby an output of the engine decreases. Thus, an engine has been suggested in which an intercooler is provided to decrease the intake air temperature. However, when the intercooler is provided, the structure becomes complicated, and also it is necessary to ensure a space for installing the intercooler.

### SUMMARY OF THE INVENTION

An object of the present invention is to provide a supercharger for an engine which supercharger is able to suppress an increase in intake air temperature with a simple structure to improve an output of the engine.

In order to achieve the above-described object, a supercharger according to the present invention which pressurizes intake air for the engine. The supercharger includes: a centrifugal impeller; and an impeller housing covering the impeller. The impeller housing has: a spiral chamber which forms a discharge passage for air compressed by the impeller; and a diffuser chamber defined downstream of the spiral chamber, and at least a portion of an inner surface of the diffuser chamber is formed by a ground region such that the ground region has a surface roughness less than that of a non-ground region. The ground portion has a ten point average roughness or a ten point height of irregularities Rz of not greater than 5 μm.

According to this configuration, a portion of the inner surface of the diffuser chamber is by a ground region such that the ground region has a surface roughness less than that of the non-ground region. Therefore, frictional resistance, which is one of passage resistances caused when the intake air passes through the diffuser chamber, decreases. Thus, an increase in the intake air temperature is suppressed to improve charging efficiency. As a result, an output of the engine improves. In addition, since the inner surface of the diffuser chamber is merely ground, the structure is simple.

In the present invention, at least an inner surface of a radially outer portion of the diffuser chamber in a region extending over an upstream side from a discharge port is preferably formed by the ground region. According to this configuration, the inner surface of the radially outer portion of the diffuser chamber is a surface against which the intake air is pressed by a centrifugal force. Thus, by decreasing the surface roughness of this surface, an increase in the intake air temperature is easily suppressed.

In the present invention, preferably, the impeller housing is a sand casting product, and a discharge port side portion including the entire diffuser chamber is formed by the ground region. According to this configuration, since the impeller housing is formed by the sand casting product, the impeller housing having a complicated shape can be easily formed. In the case of the sand casting product, if a casting surface remains, the surface of the impeller housing is rough. However, by forming the ground region on the inner surface of the diffuser chamber as described above, the passage resistance reduces, and therefore, an increase in the intake air temperature is suppressed. Accordingly, the charging efficiency improves.

In the present invention, preferably, an inner surface of the impeller housing is formed with a painting film, and the painting film on the ground region is removed by grinding the inner surface to form the ground region. According to this configuration, since the inner surface is formed with the painting film, the roughness of the inner surface decreases to reduce the passage resistance, whereby an increase in the intake air temperature is suppressed. Accordingly, the charging efficiency improves. Furthermore, since the ground region is formed by grinding the painting film, the roughness of the inner surface further decreases, and the painting film on the ground region is removed. Therefore, it is easy to confirm that the grinding has been performed.

The supercharger of the present invention is particularly effective for an engine in which the temperature of intake air supplied to the engine from the supercharger is not lower than 90° C. Although in such an engine, a decrease in the intake air temperature is needed, with the supercharger of the present invention, an increase in the intake air temperature can be suppressed without an intercooler. Thus, the engine E can be reduced in size.

The supercharger of the present invention is also suitably used in an engine mounted on a saddle-riding type vehicle including an air intake chamber which stores the intake air from the supercharger. In the saddle-riding type vehicle, since a space for the air intake chamber is limited, it is difficult to decrease the intake air temperature due to expansion by increasing the size of the air intake chamber, and thus the intake air temperature tends to easily increase. However, with the supercharger of the present invention, an increase in the intake air temperature can be suppressed without an intercooler, and thus an increase in the size of the saddle-riding type vehicle can be suppressed.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a side view showing a motorcycle which is one type of a saddle-riding type vehicle equipped with an engine including a supercharger according to a first preferred embodiment of the present invention;

FIG. 2 is a perspective view of the engine as seen from the rear and obliquely above;

FIG. 3 is a cross-sectional view of an impeller housing of the supercharger along a rotation shaft;

FIG. 4 is a cross-sectional view taken along a line IV-IV in FIG. 3;

FIG. 5 is a cross-sectional view showing a ground region and a non-ground region of the impeller housing; and

FIG. 6 is a chart showing outputs and intake air temperatures of the engine including the supercharger and an engine including a conventional supercharger.

### DESCRIPTION OF PREFERRED EMBODIMENTS

Hereinafter, preferred embodiments of the present invention will be described with reference to the drawings. The terms “left side” and “right side” used in this specification are the left side and the right side relative to a driver maneuvering a vehicle to travel forwards.

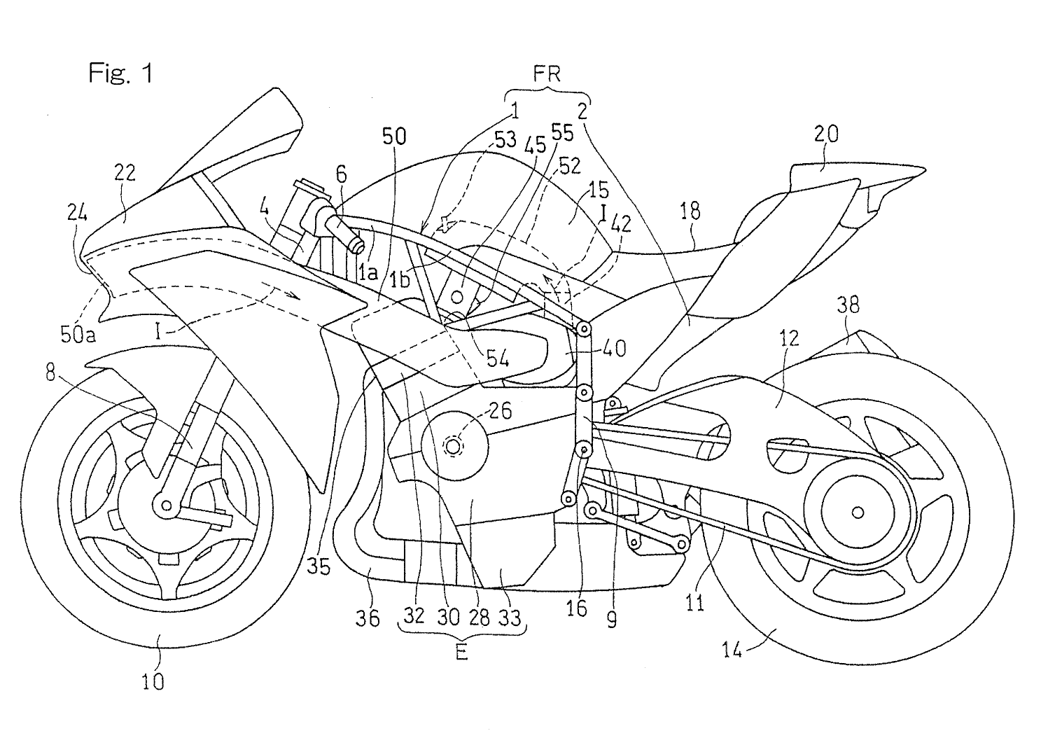

FIG. 1 is a side view of a motorcycle including a supercharger, for an engine, according to a first preferred embodiment of the present invention. A motorcycle frame structure FR includes a main frame 1 which forms a front half of the motorcycle frame structure FR, and a rear frame 2 which forms a rear half of the motorcycle frame structure FR. A head pipe 4 is provided at a front end of the main frame 1, and a front fork 8 is rotatably supported by the head pipe 4 through a steering shaft (not shown). A steering handle 6 is fixed to an upper end portion of the front fork 8, and a front wheel 10 is fitted to a lower end portion of the front fork 8.

A swingarm bracket 9 is provided at a rear end portion of the main frame 1. A swingarm 12 is supported by the swingarm bracket 9 for swing movement in a vertical direction about a pivot shaft 16 which is mounted to the swingarm bracket 9. A rear wheel 14 is rotatably supported by a rear end portion of the swingarm 12.

A combustion engine E is fitted to a lower intermediate portion of the motorcycle frame structure FR at the front side of the swingarm bracket 9. The engine E drives the rear wheel 14 through a drive chain 11. The engine E is a parallel multi-cylinder combustion engine having a plurality of cylinders aligned in the axial direction of a crankshaft 26 which is an engine rotation shaft. In the present embodiment, the engine E is a multi-cylinder water-cooled combustion engine having four cylinders with four cycles. However, the type of the engine E is not limited thereto.

The engine E includes: a crankcase 28 which supports the crankshaft 26; a cylinder block 30 which projects upward from an upper surface of a front portion of the crankcase 28; a cylinder head 32 disposed above the cylinder block 30; and an oil pan 33 connected to a lower portion of the crankcase 28. The cylinder block 30 and the cylinder head 32 are inclined frontward and form a cylinder of the engine E. That is, the engine E has a substantially L shape in a side view.

Four exhaust pipes 36 are connected to four exhaust ports 35 in a front surface of the cylinder head 32. The four exhaust pipes 36 are merged together at a location beneath the engine E, and are connected to an exhaust muffler 38 which is disposed at the right side of the rear wheel 14.

A fuel tank 15 is disposed on an upper portion of the main frame 1, and a rider's seat 18 and a passenger's seat 20 are supported by the rear frame 2. In addition, a fairing 22 made of a resinous material is mounted on a front portion of the motorcycle. The fairing 22 covers a portion from front of the head pipe 4 to outer lateral sides of the front portion of the motorcycle. An air inlet 24 is formed in the fairing 22. The air inlet 24 is located at a front end of the fairing 22, and takes in intake air from the outside to the engine E.

An air intake duct 50 is disposed at the left side of the motorcycle frame structure FR. The air intake duct 50 is supported by the head pipe 4 such that a front end opening 50a thereof faces the air inlet 24 of the fairing 22. That is, the front end opening 50a of the air intake duct 50 communicates with the air inlet 24. The pressure of air introduced through the front end opening 50a of the air intake duct 50 is increased by a ram effect.

An air cleaner 40 and a supercharger 42 are disposed rearward of the cylinder block 30 and on an upper surface of a rear portion of the crankcase 28 so as to be aligned in a widthwise direction of the motorcycle such that the air cleaner 40 is located at the outer side. The air intake duct 50 passes from front of the engine E through left outer lateral sides of the cylinder block 30 and the cylinder head 32 to introduce incoming wind as intake air I into the air cleaner 40. The supercharger 42 pressurizes air cleaned by the air cleaner 40 and supplies the cleaned air to the engine E.

An air intake chamber 52 is disposed between the supercharger 42 and an air intake port 54 in a rear portion of the cylinder head 32, and the supercharger 42 and the air intake chamber 52 are directly connected to each other. The air intake chamber 52 stores high-pressure intake air I supplied from the supercharger 42. The air intake chamber 52 of the present embodiment has a capacity which is about twice the displacement of the engine E. A throttle body 44 is fluidly connected between the air intake chamber 52 and the air intake port 54. A main injector 55, which injects fuel into the intake air, is mounted on the throttle body 44. In addition, top injectors 53 which inject the fuel into the air intake chamber 52 are mounted on an upper portion of the air intake chamber 52.

The air intake chamber 52 is disposed above the supercharger 42 and the throttle body 44, and rearward of the cylinder head 32. The air cleaner 40 is disposed between the crankcase 28 and the air intake chamber 52 above the crankcase 28, in a side view. The fuel tank 15 is disposed above the air intake chamber 52 and the throttle body 44.

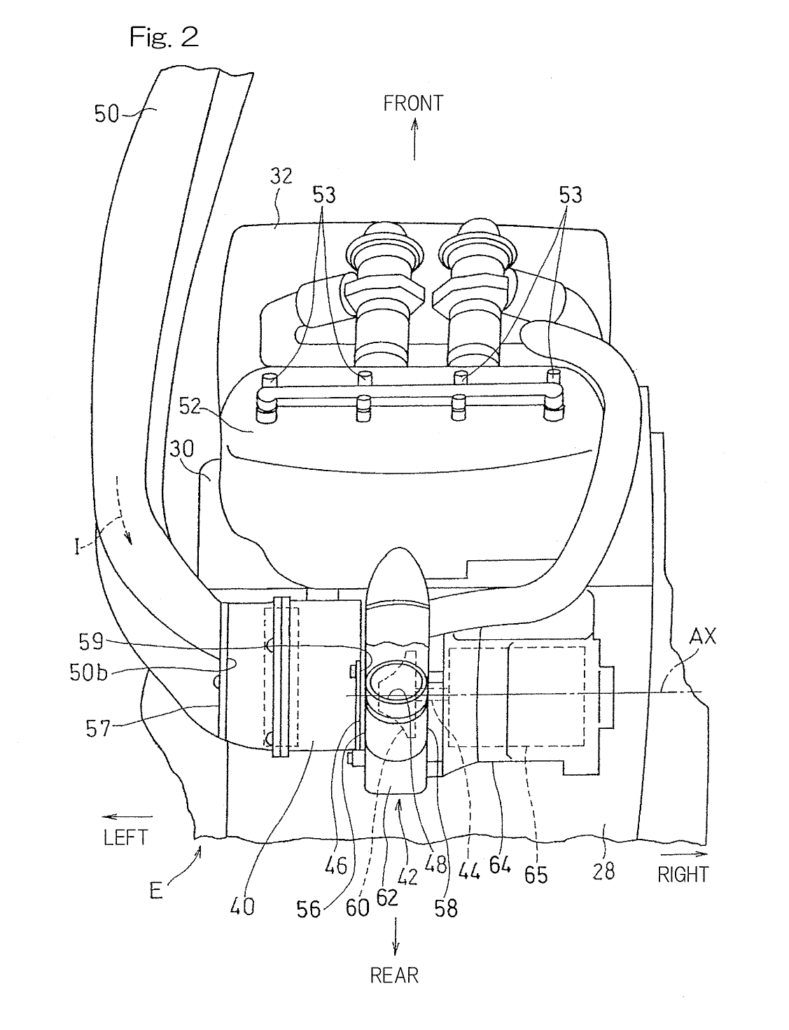

As shown in FIG. 2, the supercharger 42 is disposed at the right side of the air cleaner 40, and fixed to an upper surface of the crankcase 28 by means of a bolt (not shown). The supercharger 42 is a mechanical supercharger driven by the crankshaft (rotation shaft) 26 of the engine E and includes a supercharger rotation shaft 44 having a rotation axis AX extending in the widthwise direction of the motorcycle (right-left direction). The supercharger 42 has a suction port 46 which is located above the crankcase 28 and at a center portion of the engine E in the widthwise direction of the motorcycle. The suction port 46 is opened leftward. The supercharger 42 also has a discharge port 48 which is located above the crankcase 28 and at the center portion of the engine E in the widthwise direction of the motorcycle. The discharge port 48 is opened upward. An outlet 59 of the air cleaner 40 is connected to the suction port 46 of the supercharger 42, and a rear end portion 50b of the air intake duct 50 is connected to an inlet 57 of the air cleaner 40 from the outer side in the widthwise direction of the motorcycle.

The supercharger 42 includes: a centrifugal impeller 60 which is fixed to one end portion (left end portion) 44a of the supercharger rotation shaft 44; an impeller housing 62 which covers the impeller 60; a supercharger casing 64 which rotatably supports the supercharger rotation shaft 44; and a speed increasing device 65 which increases the speed of rotation of the crankshaft 26 of the engine E and transmits the rotation so increased to the supercharger rotation shaft 44. By the speed increasing device 65, the maximum rotational speed of the supercharger rotation shaft 44 becomes equal to or higher than 100 thousands rpm, and is about 140 thousands rpm in the present embodiment. With the centrifugal supercharger 42, the intake air I is compressed, and at the discharge port 48 the intake air temperature tends to be high. In the present embodiment, the intake air temperature is equal to or higher than 90° C. In addition, the supercharger 42 of the present embodiment has a high compression ratio, and the compression ratio is equal to or higher than 2, specifically, is set to 2.5.

The air intake duct 50, the air cleaner 40, the impeller housing 62, and the supercharger casing 64 are made of metal. The air intake duct 50 and the air cleaner 40 are connected to each other by means of a bolt (not shown), and the impeller housing 62 is connected to the supercharger casing 64 and the air cleaner 40 by means of a bolt (not shown). That is, the impeller housing 62 has: a first end surface 56 which is in surface contact with the air cleaner 40; and a second end surface 58 which is in surface contact with the supercharger casing 64. Since the impeller housing 62 is in surface contact with the supercharger casing 64 and is in surface contact with the air intake duct 50 through the air cleaner 40, heat dissipation of the impeller housing 62 improves.

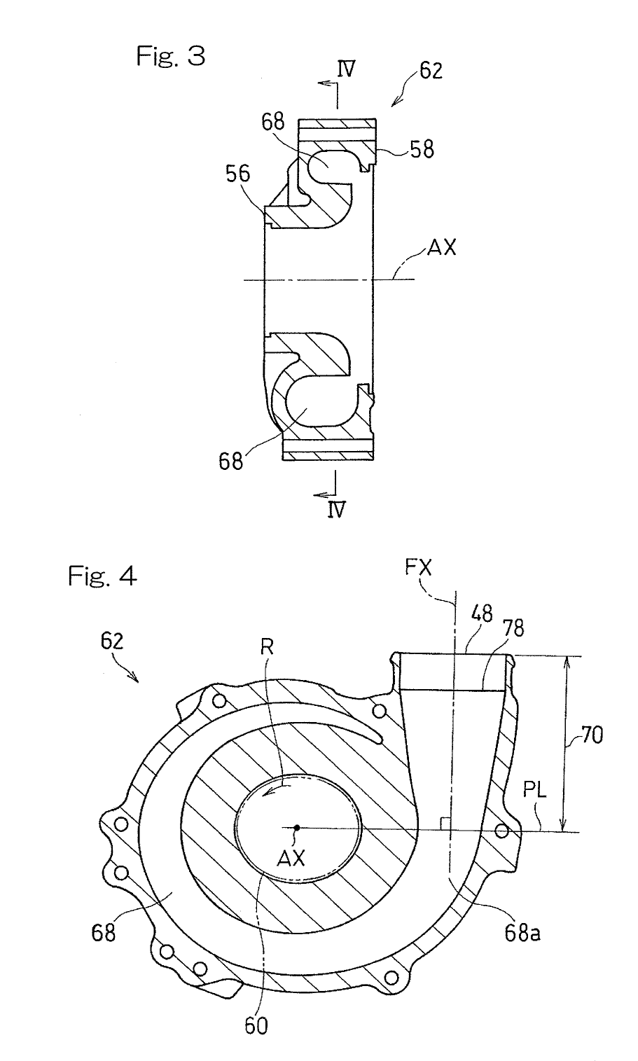

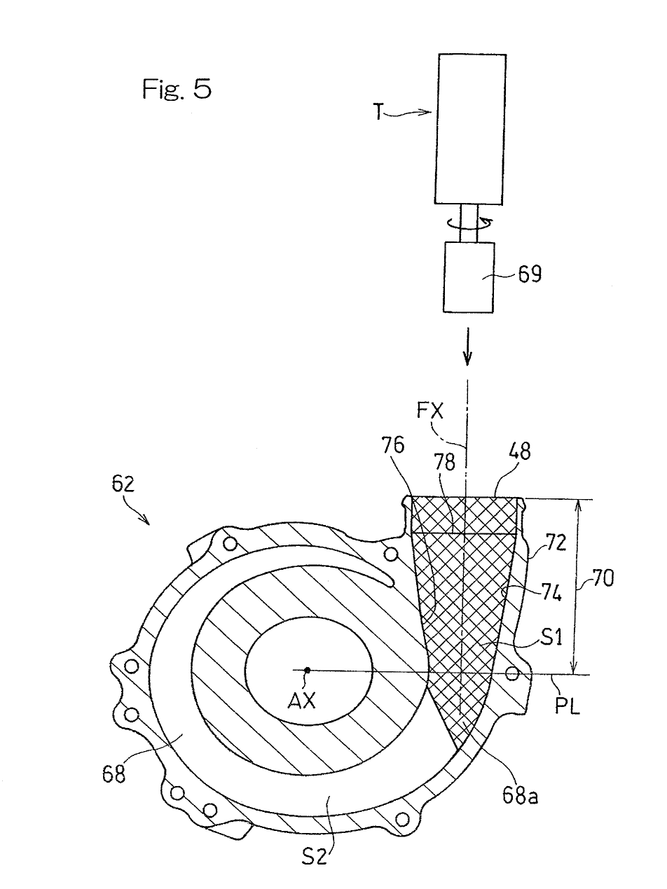

FIG. 4 shows a cross section which is perpendicular to the rotation axis AX of the impeller housing 62 and taken along a line IV-IV in FIG. 3. As shown in FIG. 4, the impeller housing 62 has: a spiral chamber 68 which forms a discharge passage for air compressed by the impeller 60 that rotates in an R direction; and a diffuser chamber 70 defined downstream of the spiral chamber 68. A portion of an inner surface of the impeller housing 62 is polished or ground. The diffuser chamber 70 has a substantially conical shape having a straight axis FX.

Due to the grinding, a ground region Si shown by cross hatching in FIG. 5 has a surface roughness less than that of a non-ground region S2. In the present embodiment, the inner surface of a discharge port side portion including the entire diffuser chamber 70 and the inner surface of a downstream portion 68a of the spiral chamber 68 that is connected to the diffuser chamber 70 are ground. However, at least a portion of the inner surface of the diffuser chamber 70 only needs to be ground, and, for example, only the inner surface of a radially outer portion 72 of the diffuser chamber 70 in a region extending over the upstream side from the discharge port 48 may be ground.

A method for manufacturing the impeller housing 62 will now be described. The impeller housing 62 is a sand casting product. The impeller housing 62 is formed by sand casting, not by die casting, and therefore, a low brittle material can be used, whereby the thickness of the impeller housing 62 can be reduced. In addition, by using a core, the impeller housing 62 having a complicated shape can be easily formed. In the present embodiment, the impeller housing 62 is made from AC4CH (aluminum alloy casting). The surface roughness of the casting surface is about 25 μm in ten point height of irregularities Rz.

Subsequently, an outer surface and the inner surface of the impeller housing 62 are paint-coated. In the present embodiment, powder coating is performed by using a silicone based solvent paint. As a result of the painting, the surface of the impeller housing 62 is colored and the surface roughness of the impeller housing 62 is rendered to be equal to or less than 10 μm in ten point height of irregularities Rz. Accordingly, a surface of the non-ground region in the spiral chamber 68, or a non-ground surface, has the surface roughness of 10 μm in ten point height of irregularities Rz.

Further, the inner surface of the impeller housing 62 is ground. In the present embodiment, the grinding is performed by using a grinding belt or abrasive belt 69 having about 240 in grain size. Specifically, as shown in FIG. 5, the grinding belt 69 is mounted to an end of a rotating tool T, and while the grinding belt 69 is rotated by driving of the rotating tool T, the grinding belt 69 is inserted into the impeller housing 62 through the discharge port 48. Thereafter, the inner surface of the impeller housing 62 is ground.

In the present embodiment, the substantially entire surface in a range that can be seen through the discharge port 48 is ground over the entire circumference of a cross section perpendicular to the rotation axis AX.

Specifically, the grinding is performed on a region from the discharge port 48 to a portion having a diameter reduced toward the upstream, that is, a portion into which the grinding belt 69 at the end of the rotating tool T can be inserted straight in the direction of the axis FX of the diffuser chamber 70, that is, the diffuser axis FX. Thus, the ground region S1 shown in FIG. 5 is formed so as to extend continuously over the upstream side from the discharge port 48.

The ground region Si extends from the discharge port 48 to the downstream portion 68a of the spiral chamber 68 slightly beyond a perpendicular line PL which is drawn from the rotation axis AX shown in FIG. 5 so as to be perpendicular to the diffuser axis FX as seen in a cross section perpendicular to the rotation axis AX. In the present embodiment, an upstream end edge of the diffuser chamber 70 and the perpendicular line PL substantially coincide with each other. In addition, of a radially outer portion 74 and a radially inner portion 76 of the inner surface of the impeller housing 62, the ground region S1 is formed so as to be longer in the radially outer portion 74. That is, the ground region S1 at the radially outer side is ground to the more upstream side.

By grinding the inner surface of the impeller housing 62, a painting film on the ground region Si is removed and at the same time the ground region S1 is formed. The surface of the ground region S1 preferably has a ten point height of irregularities Rz of not greater than 5 μm. In the present embodiment, the ten point height of irregularities Rz is about 3.2 μm. In other words, the ground region S1 is ground to such a degree that there is no protruded step in a trace of a core extrusion pin seat at the time of sand casting and a parting line of the core does not remain. However, the casting surface may remain in a step 78 in the vicinity of the discharge port 48.

After completion of the grinding, the first and second end surfaces 56 and 58 shown in FIG. 3 are formed by machining. However, after the coating, machining may be performed before grinding.

According to the above-described configuration, the entire inner surface of the diffuser chamber 70 shown in FIG. 5 is ground, whereby the surface roughness of the ground region Si is less than that of the non-ground region S2 or the non-ground surface. Therefore, the frictional resistance caused when the intake air I passes through the diffuser chamber 70 decreases. Thus, an increase in the intake air temperature is suppressed to improve charging efficiency. As a result, an output of the engine improves.

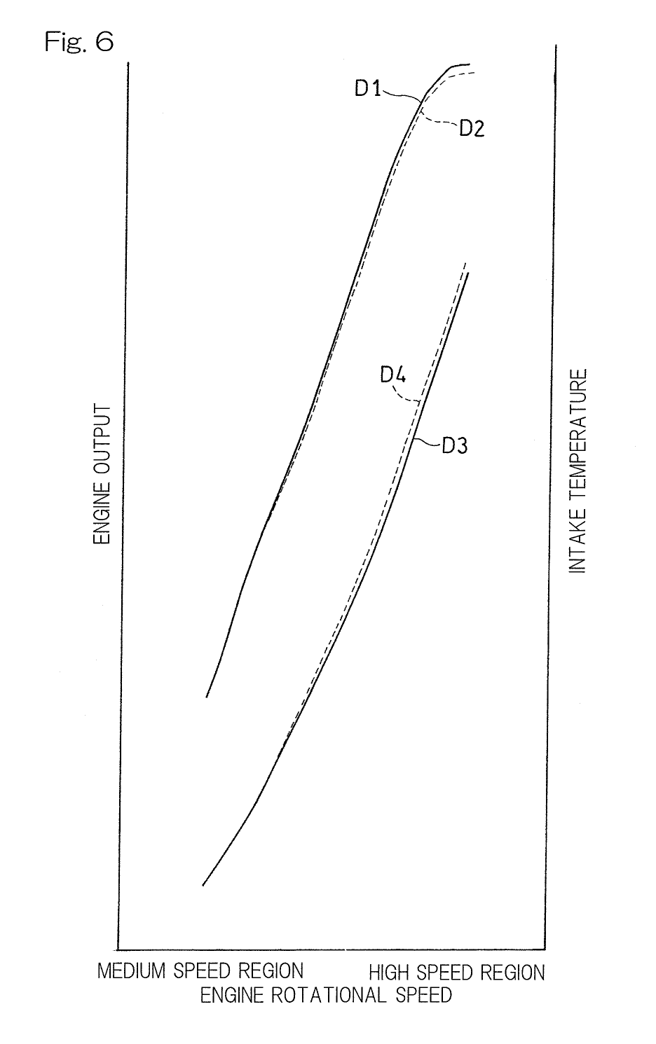

FIG. 6 is a chart showing engine outputs and intake air temperatures of the engine E including the supercharger 42 of the present embodiment and an engine of a comparative example including a conventional supercharger having a non-ground inner surface. In the chart, data D1 shows the output of the engine E of the present embodiment, and data D2 shows the output of the engine of the comparative example. In addition, data D3 shows the intake air temperature of the engine E of the present embodiment, and data D4 shows the intake air temperature of the engine of the comparative example. As the intake air temperature, the temperature within the air intake chamber 52 (FIG. 1) is measured.

As shown in the chart of FIG. 6, regarding the engine E of the present embodiment, in a high output region of the engine, an increase in the intake air temperature is suppressed, and the output of the engine improves. Specifically, in the high output region, the intake air temperature is lower by about 5° C., and the output of the engine improves by about 1%. The chart of FIG. 6 shows data in the case where the ignition timing is the same. When the intake air temperature becomes lower, a lag of the ignition timing or ignition retard can be suppressed, whereby knocking is easily prevented. Since a lag of the ignition timing is suppressed as described above, the output of the engine is further improved. Furthermore, the inner surface of the diffuser chamber 70 is merely ground, and also a device for cooling intake air, such as an intercooler, is not needed. Thus, the structure is simple.

With the engine E of the present embodiment, also in low and medium speed regions other than the high output region, the running performance of the engine improves. Specifically, by grinding the inner surface of the diffuser chamber 70 to decrease passage resistance, a delay until the output actually changes in response to an output change command from a rider is reduced. Thus, the acceleration performance of the engine and the travelling feeling of the rider improve.

Furthermore, in the present embodiment, the top injectors 53, which inject the fuel into the air intake chamber 52, are provided as shown in FIG. 2. Therefore, the intake air temperature within the air intake chamber 52 further decreases due to vaporization heat of the fuel injected into the air intake chamber 52 when the fuel vaporizes.

The inner surface of the radially outer portion 72 of the diffuser chamber 70 is a surface against which the intake air is pressed by a centrifugal force. Therefore, in particular, by grinding the inner surface of the radially outer portion 72 of the diffuser chamber 70 to decrease the surface roughness of this surface, an increase in the intake air temperature can be effectively suppressed. Since the supercharger 42 having the above-described configuration has a high compression ratio, such grinding is particularly effective for the supercharger 42.

Since the impeller housing 62 is formed by sand casting, the impeller housing 62 having a complicated shape can be easily formed. In the case of using sand casting, if a casting surface remains, the surface of the impeller housing 62 is rough (Rz=about 25 μm). However, the surface roughness of the impeller housing 62 is decreased (Rz=about 3.2 μm) by grinding the inner surface of the diffuser chamber 70. Thus, the passage resistance reduces, whereby an increase in the intake air temperature is suppressed to improve the charging efficiency.

Since the inner surface of the impeller housing 62 is paint-coated (Rz=about 10 μm), the passage resistance reduces, and therefore, an increase in the intake air temperature is suppressed to improve the charging efficiency. Furthermore, by performing the grinding after the painting, the painting film on the ground region 51 shown in FIG. 5 is removed, whereby it is easy to confirm that the grinding has been performed.

The supercharger 42 of the present invention is particularly effective for an engine E having an intake air temperature of not lower than 90° C. In such an engine, a decrease in the intake air temperature is needed. With the supercharger 42 of the present invention, an increase in the intake air temperature can be suppressed without an intercooler, and thus the engine E can be reduced in size.

The supercharger 42 of the present invention is also suitably used in an engine mounted on a saddle-riding type vehicle including the air intake chamber 52 shown in FIG. 1. In the saddle-riding type vehicle, since a space for the air intake chamber is limited, it is difficult to decrease the intake air temperature due to expansion by increasing the size of the air intake chamber 52, and thus the intake air temperature tends to easily increase. However, with the supercharger 42 of the present invention, an increase in the intake air temperature can be suppressed without an intercooler, and thus an increase in the size of the saddle-riding type vehicle can be suppressed.

The present invention is not limited to the above-described embodiment, and various additions, changes, or deletions can be made without departing from the gist of the present invention. For example, although the inner surface and the outer surface of the impeller housing 62 are paint-coated in the above embodiment, only either the inner surface or the outer surface may be paint-coated, or the coating step may be omitted. Furthermore, the supercharger 42 of the present invention is applicable to an engine including an intercooler. By so doing, the intake air temperature further decreases.

Although in the above embodiment the supercharger 42 is applied to the engine of the motorcycle, the supercharger 42 of the present invention is also applicable to an engine of a vehicle other than a motorcycle, a water craft, or the like, and is further applicable to an engine installed on the ground. Therefore, these are construed as included within the scope of the present invention.

### REFERENCE NUMERALS

42 . . . supercharger
48 . . . discharge port
52 . . . air intake chamber
60 . . . impeller
62 . . . impeller housing
68 . . . spiral chamber
70 . . . diffuser chamber
E . . . engine
I . . . intake air
S1 . . . ground region
S2 . . . non-ground region

What is claimed is:

1. A supercharger for pressurizing intake air for the engine, the supercharger comprising:
a centrifugal impeller; and
an impeller housing covering the impeller, wherein
the impeller housing has: a spiral chamber which forms a discharge passage for air compressed by the impeller; and a diffuser chamber defined downstream of the spiral chamber, and
at least a portion of an inner surface of the diffuser chamber is formed by a ground region such that the ground region has a surface roughness less than that of a non-ground region.

2. The supercharger for the engine as claimed in claim 1, wherein at least an inner surface of a radially outer portion of the diffuser chamber in a region extending over an upstream side from a discharge port is formed by the ground region.

3. The supercharger for the engine as claimed in claim 2, wherein
the impeller housing is a sand casting product, and
a discharge port side portion including the entire diffuser chamber is formed by the ground region.

4. The supercharger for the engine as claimed in claim 1, wherein
an inner surface of the impeller housing is formed with a painting film, and
the painting film on the ground region is removed by grinding the inner surface to form the ground region.

5. The supercharger for the engine as claimed in claim 1, wherein the ground region has a ten point height of irregularities Rz of not greater than 5 gm.

6. The supercharger for the engine as claimed in claim 1, wherein the intake air supplied to the engine from the supercharger has a temperature of not lower than 90° C.

7. The supercharger for the engine as claimed in claim 1, wherein
the engine is mounted on a saddle-riding type vehicle, and
the saddle-riding type vehicle includes an air intake chamber connected to a discharge port of the supercharger and configured to store the intake air.
